(19) United States
(12) Patent Application Publication
(10) Pub. No.: US 2015/0252460 A1
(43) Pub. Date: Sep. 10, 2015

(54) METHOD FOR IMPROVING MECHANICAL PROPERTIES OF ALUMINUM ALLOY CASTINGS

(71) Applicant: CITIC Dicastal Co., Ltd., Qinhuangdao (CN)

(72) Inventors: Wang Lisheng, Qinhuangdao (CN); Zhang Zhendong, Qinhuangdao (CN); Liu Chunhai, Qinhuangdao (CN); Wang Yongning, Qinhuangdao (CN); Zhu Zhihua, Qinhuangdao (CN); Li Changhai, Qinhuangdao (CN)

(21) Appl. No.: 14/639,638

(22) Filed: Mar. 5, 2015

(30) Foreign Application Priority Data
Mar. 5, 2014 (CN) 201410077236.5

(51) Int. Cl. C22F 1/04; B05D 5/00; B05D 3/02; B05D 7/14; C22F 1/00; C22C 21/00

(52) U.S. Cl. CPC C22F 1/04; C22F 1/002; C22C 21/00; B05D 3/0218; B05D 7/14; B05D 5/00

(57) ABSTRACT

The present invention discloses a method for improving mechanical properties of aluminum alloy casting. The advantages of the present invention lie in: combining heat-treatment with thermal painting; dividing the solution treatment of conventional T6 heat treatment process into two separate solution treatments, which avoids deformation and overheating of the casting due to melting of the ternary eutectic structures with low melting point, thereby improving efficiency of the heat-treatment and lowering the amount of energy consumed and the cost of production.

The present invention claims priority to Chinese Patent Application No. CN201410077236.5, which is incorporated herein for reference.

### TECHNICAL FIELD

The present invention relates to a method for aluminum alloy heat-treatment.

### BACKGROUND OF THE INVENTION

A356.2 alloy is a cast aluminum alloy of Al—Si—Mg family, which is widely used in the casting of automobile wheels. In order to further increase the mechanical properties of this material, it is usually treated by means of conventional T6 heat-treatment process. However, the existing heat-treatment processes take more than 10 hours, severely lowering production efficiency and meanwhile causing huge consumption of energy. Therefore, it is necessary to develop a new heat-treatment process which requires shorter time. Additionally, thermally painting the A356.2 casting heat-treated by existing processes, will enhance its yield strength and tensile strength, but lower its ductility. For components requiring high ductility, this will result in a lot of deficient products, thereby causing waste and lowering the rate of qualified products.

### SUMMARY OF THE INVENTION

In order to solve the problem described above, we have developed a heat-treatment process with short term solution and ageing, so as to combine with thermal painting.

It is an object of the present invention to combine heat-treatment with thermal painting so as to overcome the drawbacks of the existing heat-treatment processes.

The technical solution of the present invention includes the following steps: subjecting the casting to a first solution treatment during which the temperature is set at 530-540° C. and the soaking time is set as 30-60 minutes; subjecting the casting to a second solution treatment during which the temperature is set at 550-560° C. and the soaking time is set as 60-90 minutes; then quenching the casting in water at a temperature of 40-80° C. for 1-3 minutes, wherein the time it takes to move the casting from the solution treatment furnace into the quenching media should be less than 30 seconds; then subjecting the casting to ageing treatment during which the temperature is set at 160-200° C. and the time is set as 60-120 minutes, and then naturally cooling the casting in the air to room temperature; after heat-treating the casting as described above, subjecting the casting to thermal painting during which the temperature is set at 200-300° C. and the duration time is set as 20-30 minutes, and then naturally cooling the casting in the air to room temperature.

As compared with other existing processes, the advantages of the present invention lie in: combining heat-treatment with thermal painting; dividing the solution treatment of conventional T6 heat-treatment process into two separate solution treatments, thereby avoiding deformation and overheating of the casting due to melting of ternary eutectic structures with low melting point; reducing the processing time and improving the efficiency, thereby cutting down the amount of energy consumption and production cost.

### DETAILED DESCRIPTION OF THE EMBODIMENTS

In order for the technical means of the present invention to be better understood, they will thereafter be further explained in conjunction with the embodiments. However, it is not intended that such embodiments be construed as limitations upon the scope of the invention.

### Example 1

The method according to the first example of the present invention comprises the following steps: deliver the casting into a first chamber of a continuous solution treatment furnace, in which the temperature is set at 535° C±5° C., and keep the casting in the chamber for 60 minutes in order that the Mg₂Si phase will dissolve into the α-Al matrix; then deliver the casting into a second chamber of the continuous solution treatment furnace, in which the temperature is set at 560° C±5° C., and keep the casting in the chamber for 60 minutes in order to further make the elements of Mg and Si sufficiently dissolve into the α-Al matrix; move the casting into water at a temperature of 60° C. and quench it in the water for 2 minutes, wherein the time it takes to move the casting from the solution treatment furnace into the quenching media should be less than 30 seconds; then move the casting into an ageing furnace for ageing treatment during which the temperature is set at 180° C±5° C., and keep it in the furnace for 120 minutes, and then take the casting out and keep it in the air until it is naturally cooled to room temperature; after being heat-treated as described above, subject the casting to thermal painting during which the temperature is set at 200° C. and the duration time is set as 30 minutes, and then keep it in the air until it is naturally cooled to room temperature. After treating the casting as described above, there is no obvious change in the yield strength, tensile strength, ductility of the casting as compared with those treated by means of conventional T6 heat-treatment process and painting process.

### Example 2

The method according to the second example of the present invention comprises the following steps: deliver the casting into a first chamber of a continuous solution treatment furnace, in which the temperature is set at 535° C.±5 ° C., and keep the casting in the chamber for 60 minutes in order that the Mg₂Si phase will dissolve into the α-Al matrix; then deliver the casting into a second chamber of the continuous solution treatment furnace, in which the temperature is set at 560° C.±5° C., and keep the casting in the chamber for 60 minutes in order to further make the elements of Mg and Si sufficiently dissolve into the α-Al matrix; move the casting into water at a temperature of 60° C. and quench it in the water for 2 minutes, wherein the time it takes to move the casting from the solution treatment furnace into the quenching media should be less than 30 seconds; then move the casting into an ageing furnace for ageing treatment during which the temperature is set at 200° C.±5° C., and keep it in the furnace for 60 minutes, and then take the casting out and keep it in the air until it is naturally cooled to room temperature; after being heat-treated as described above, subject the casting to thermal painting during which the temperature is set at 200° C. and the duration time is set as 30 minutes, and then keep it in the air until it is naturally cooled to room temperature. After treating the casting as described above, as compared with those treated by means of conventional T6 heat-treatment process and painting process, the yield strength and tensile strength of the casting are slightly lowered, and there is no obvious change in its ductility.

### Example 3

The method according to the third example of the present invention comprises the following steps: deliver the casting into a first chamber of a continuous solution treatment furnace, in which the temperature is set at 535° C.±5° C., and keep the casting in the chamber for 60 minutes in order that the Mg₂Si phase will dissolve into the α-Al matrix; then deliver the casting into a second chamber of the continuous solution treatment furnace, in which the temperature is set at 560° C.±5° C., and keep the casting in the chamber for 60 minutes in order to further make the elements of Mg and Si sufficiently dissolve into the α-Al matrix; move the casting into water at a temperature of 60° C. and quench it in the water for 2 minutes, wherein the time it takes to move the casting from the solution treatment furnace into the quenching media should be less than 30 seconds; then move the casting into an ageing furnace for ageing treatment during which the temperature is set at 200° C.±5° C., and keep it in the furnace for 60 minutes, and then take the casting out and keep it in the air until it is naturally cooled to room temperature; after being heat-treated as described above, subject the casting to thermal painting during which the temperature is set at 300° C. and the duration time is set as 30 minutes, and then keep it in the air until it is naturally cooled to room temperature. After treating the casting as described above, as compared with those treated by means of conventional T6 heat-treatment treatment process and painting process, the yield strength and tensile strength of the casting are slightly lowered, but its ductility is obviously enhanced.

### Example 4

The method according to the fourth example of the present invention comprises the following steps: deliver the casting into a first chamber of a continuous solution treatment furnace, in which the temperature is set at 535° C.±5° C., and keep the casting in the chamber for 60 minutes in order that the Mg₂Si phase will dissolve into the α-Al matrix; then deliver the casting into a second chamber of the continuous solution treatment furnace, in which the temperature is set at 560° C. ±5° C., and keep the casting in the chamber for 60 minutes in order to further make the elements of Mg and Si sufficiently dissolve into the α-Al matrix; move the casting into water at a temperature of 60° C. and quench it in the water for 2 minutes, wherein the time it takes to move the casting from the solution treatment furnace into the quenching media should be less than 30 seconds; then move the casting into an ageing furnace for ageing treatment during which the temperature is set at 180° C.±5° C., and keep it in the furnace for 120 minutes, and then take the casting out and keep it in the air until it is naturally cooled to room temperature; after being heat-treated as described above, subject the casting to thermal painting during which the temperature is set at 300° C. and the time is set as 20 minutes, and then keep it in the air until it is naturally cooled to room temperature. After treating the casting as described above, as compared with those treated by means of conventional T6 heat-treatment process and painting process, there is no obvious change in the yield strength and tensile strength of the casting, but its ductility is obviously enhanced.

1. A method for improving mechanical properties of aluminum alloy castings, characterized in that, said method comprises:
subjecting the casting to a first solution treatment during which the temperature is set at 530-540° C. and the soaking time is set as 30-60 minutes;
subjecting the casting to a second solution treatment during which the temperature is set at 550-560° C. and the soaking time is set as 60-90 minutes;
then quenching the casting in water at a temperature of 40-80° C. for 1-3 minutes, wherein the time it takes to move the casting from the solution treatment furnace into the quenching media should be less than 30 seconds;
subjecting the casting to ageing treatment during which the temperature is set at 160-200° C. and the soaking time is set as 60-120 minutes, then keeping the casting in the air until it is naturally cooled to room temperature; and
after heat-treating the casting as described above, subjecting the casting to thermal painting during which the temperature is set at 200-300° C. and the duration time is set as 20-30 minutes, then keeping the casting in the air until it is naturally cooled to room temperature.

2. The method for improving mechanical properties of aluminum alloy castings according to claim 1, wherein the method comprises:
delivering the casting into a first chamber of a continuous solution treatment furnace, in which the temperature is set at 535° C.±5° C., and keeping the casting in the chamber for 60 minutes;
then delivering the casting into a second chamber of a continuous solution treatment furnace, in which the temperature is set at 560° C.±5° C., and keeping the casting in the chamber for 60 minutes;
quenching the casting in water at a temperature of 60° C. for 2 minutes, wherein the time it takes to move the casting from the solution treatment furnace into the quenching media should be less than 30 seconds;
moving the casting into an ageing furnace for ageing treatment during which the temperature is set at 180° C.±5° C. and the soaking time is set as 120 minutes, then keeping the casting in the air until it is naturally cooled to room temperature; and
after heat-treating the casting as described above, subjecting the casting to thermal painting during which the temperature is set at 200° C. and the duration time is set as 30 minutes, then keeping the casting in the air until it is naturally cooled to room temperature.

3. The method for improving mechanical properties of aluminum alloy castings according to claim 1, wherein the method comprises:
delivering the casting into a first chamber of a continuous solution treatment furnace, in which the temperature is set at 535° C.±5 ° C., and keeping the casting in the chamber for 60 minutes;
then delivering the casting into a second chamber of a continuous solution treatment furnace, in which the temperature is set at 560° C. ±5° C., and keeping the casting in the chamber for 60 minutes;
quenching the casting in water at a temperature of 60° C. for 2 minutes, wherein the time it takes to move the casting from the solution treatment furnace into the quenching media should be less than 30 seconds;
moving the casting into an ageing furnace for ageing treatment during which the temperature is set at 200° C.±5° C. and the soaking time is set as 60 minutes, then keeping the casting in the air until it is naturally cooled to room temperature; and
after heat-treating the casting as described above, subjecting the casting to thermal painting during which the temperature is set at 200° C. and the duration time is set as 30 minutes, then keeping the casting in the air until it is naturally cooled to room temperature.

4. The method for improving mechanical properties of aluminum alloy castings according to claim 1, wherein the method comprises:
delivering the casting into a first chamber of a continuous solution treatment furnace, in which the temperature is set at 535° C. ±5° C., and keeping the casting in the chamber for 60 minutes;
then delivering the casting into a second chamber of a continuous solution treatment furnace, in which the temperature is set at 560° C.±5° C., and keeping the casting in the chamber for 60 minutes;
quenching the casting in water at a temperature of 60° C. for 2 minutes, wherein the time it takes to move the casting from the solution treatment furnace into the quenching media should be less than 30 seconds;
moving the casting into an ageing furnace for ageing treatment during which the temperature is set at 200° C.±5° C. and the soaking time is set as 60 minutes, then keeping the casting in the air until it is naturally cooled to room temperature; and
after heat-treating the casting as described above, subjecting the casting to thermal painting during which the temperature is set at 300° C. and the duration time is set as 20 minutes, then keeping the casting in the air until it is naturally cooled to room temperature.

5. The method for improving mechanical properties of aluminum alloy castings according to claim 1, wherein the method comprises:
delivering the casting into a first chamber of a continuous solution treatment furnace, in which the temperature is set at 535° C.±5° C., and keeping the casting in the chamber for 60 minutes;
then delivering the casting into a second chamber of a continuous solution treatment furnace, in which the temperature is set at 560° C.±5° C., and keeping the casting in the chamber for 60 minutes;
quenching the casting in water at a temperature of 60° C. for 2 minutes, wherein the time it takes to move the casting from the solution treatment furnace into the quenching media should be less than 30 seconds;
moving the casting into an ageing furnace for ageing treatment during which the temperature is set at 180° C.±5° C. and the soaking time is set as 120 minutes, then keeping the casting in the air until it is naturally cooled to room temperature; and
after heat-treating the casting as described above, subjecting the casting to thermal painting during which the temperature is set at 300° C. and the duration time is set as 20 minutes, then keeping the casting in the air until it is naturally cooled to room temperature.
